(19) United States
(12) Patent Application Publication
(10) Pub. No.: US 2025/0013480 A1
(43) Pub. Date: Jan. 9, 2025

(54) DYNAMIC MIGRATION OF VIRTUAL MACHINE SNAPSHOTS TO CONTAINER PLATFORMS

(71) Applicant: International Business Machines Corporation, Armonk, NY (US)

(72) Inventors: Yao Dong Zhang, Shanghai (CN); Gang Lyu, Shanghai (CN); Wei Xian, Xian (CN); Geng Hu, Xian (CN); Dong Ping Song, Xian (CN); Ke Qiang Chen, Beijing (CN); Chun Wei Wu, Beijing (CN)

(73) Assignee: International Business Machines Corporation, Armonk, NY (US)

(21) Appl. No.: 18/219,670

(22) Filed: Jul. 8, 2023

(51) Int. Cl. G06F 9/455

(52) U.S. Cl. CPC G06F 9/45558; G06F 2009/45583

(57) ABSTRACT

A method for migrating virtual machine snapshots to application container platforms is disclosed. In one embodiment, such a method includes migrating, from a virtual machine platform to a volume on a container platform, a base disk file associated with a virtual machine. The base disk file has one or more delta disk files associated therewith, where each delta disk file records changes made to the virtual machine after a snapshot was taken. After migrating the base disk file, the method repeatedly performs the following for each delta disk file: takes a snapshot of the volume on the container platform; migrates the delta disk file from the virtual machine platform to the container platform; and writes the delta disk file to the volume. In certain embodiments, the delta disk files are written to the volume in an order in which they were created on the virtual machine.

### BACKGROUND

### Field of the Invention

This invention relates generally to application container platforms, and more particularly to techniques for migrating virtual machine snapshots to application container platforms.

### Background of the Invention

Virtual machines and containers are different technologies used to deploy and isolate applications, with each having distinct characteristics. Virtual machines run on a hypervisor and include an operating system along with an application. Unlike container platforms, virtual machines may run different operating systems. Containers, by contrast, provide lightweight, fast-starting, and scalable application runtime environments that share a host operating system with other containers. Virtual machines are frequently used for running legacy applications or when strong isolation is required. By contrast, containers are popular in modern, cloud-native application development and deployment scenarios.

Currently, there is a growing trend to deploy applications in container platforms as opposed to virtual machines. In fact, with increasing prevalence, users are opting to move their applications from virtual machines to container platforms to take advantage of a container platform's benefits. Nevertheless, moving applications from virtual machines to container platforms may present various challenges and considerations, such as dependency and library compatibility, configuration and state management, networking and inter-container communication, security, performance impacts, and the like. Each of these considerations may need to be taken into account to ensure successful transition to a container platform.

### SUMMARY

The invention has been developed in response to the present state of the art and, in particular, in response to the problems and needs in the art that have not yet been fully solved by currently available systems and methods. Accordingly, systems and methods have been developed for migrating virtual machine snapshots to application container platforms. The features and advantages of the invention will become more fully apparent from the following description and appended claims, or may be learned by practice of the invention as set forth hereinafter.

Consistent with the foregoing, a method for migrating virtual machine snapshots to application container platforms is disclosed. In one embodiment, such a method includes migrating, from a virtual machine platform to a volume on a container platform, a base disk file associated with a virtual machine. The base disk file has one or more delta disk files associated therewith, where each delta disk file records changes made to the virtual machine after a snapshot was taken. After migrating the base disk file, the method repeatedly performs the following for each delta disk file: takes a snapshot of the volume on the container platform; migrates the delta disk file from the virtual machine platform to the container platform; and writes the delta disk file to the volume. In certain embodiments, the delta disk files are written to the volume in an order in which they were created on the virtual machine. A corresponding system and computer program product are also disclosed and claimed herein.

### BRIEF DESCRIPTION OF THE DRAWINGS

In order that the advantages of the invention will be readily understood, a more particular description of the invention briefly described above will be rendered by reference to specific embodiments illustrated in the appended drawings. Understanding that these drawings depict only typical embodiments of the invention and are not therefore to be considered limiting of its scope, the embodiments of the invention will be described and explained with additional specificity and detail through use of the accompanying drawings, in which:

FIG. 1 is a high-level block diagram showing one example of a computing system for use in implementing embodiments of the invention;

FIG. 2A is a high-level block diagram showing an example of a virtual machine platform;

FIG. 2B is a high-level block diagram showing an example of a container platform;

FIG. 3 is a high-level block diagram showing various data structures that may be utilized in the virtual machine platform and the container platform when migrating snapshots between the platforms;

FIG. 4 is a high-level block diagram showing a more specific example of data structures that may utilized in the virtual machine platform and container platform when migrating snapshots between the platforms;

FIG. 5 is a high-level block diagram showing a sequence of actions that may be performed when migrating snapshots from a virtual machine platform to a container platform;

FIG. 6 is a process flow diagram showing one embodiment of a method that may be executed to migrate snapshots from a virtual machine platform to a container platform;

FIG. 7 is a high level block diagram showing an exemplary sequence of actions that may be taken to migrate snapshots from a virtual machine platform to a container platform;

FIG. 8 is a high level block diagram showing one embodiment of a snapshot migration module and various sub-modules; and

FIG. 9 is a process flow diagram showing one embodiment of a method that may be executed by the snapshot migration module.

### DETAILED DESCRIPTION

It will be readily understood that the components of the present invention, as generally described and illustrated in the Figures herein, could be arranged and designed in a wide variety of different configurations. Thus, the following more detailed description of the embodiments of the invention, as represented in the Figures, is not intended to limit the scope of the invention, as claimed, but is merely representative of certain examples of presently contemplated embodiments in accordance with the invention. The presently described embodiments will be best understood by reference to the drawings, wherein like parts are designated by like numerals throughout.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as code 150 (i.e., a “snapshot migration module 150”) for migrating snapshots from a virtual machine platform to a container platform. In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

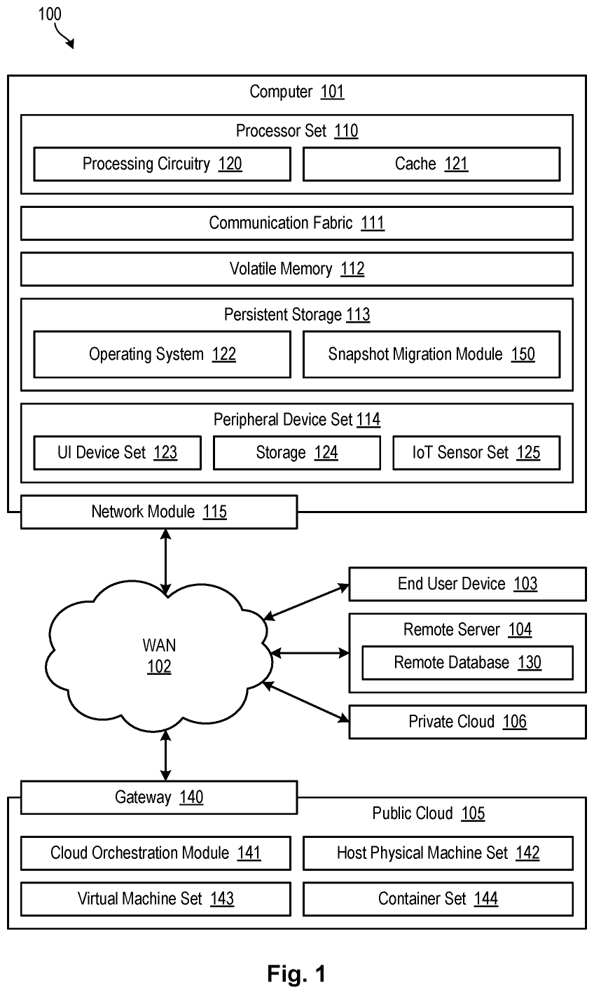

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

Communication fabric 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 150 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

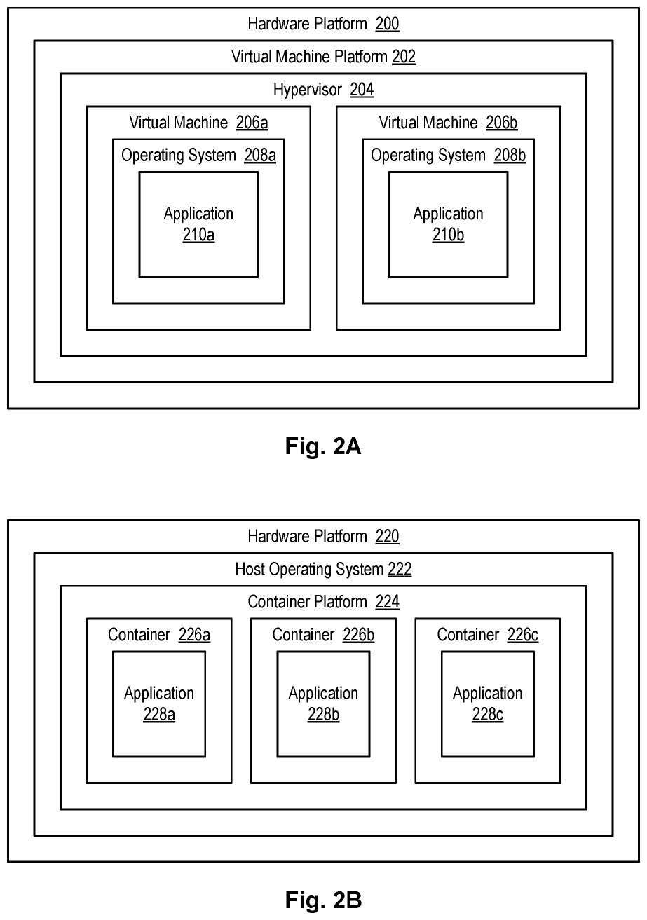

Referring to FIG. 2, as previously mentioned, virtual machines and containers are different technologies used to deploy and isolate applications, with each having distinct characteristics. Virtual machines run on a hypervisor and include an operating system along with an application. Unlike container platforms, virtual machines may run different operating systems. Containers, by contrast, provide lightweight, fast-starting, and scalable application runtime environments that share a host operating system with other containers. Virtual machines are frequently used for running legacy applications or when strong isolation is required. By contrast, containers are popular in modern, cloud-native application development and deployment scenarios.

Currently, there is a growing trend to deploy applications in container platforms as opposed to virtual machines. In fact, with increasing prevalence, users are opting to move their applications from virtual machines to container platforms to take advantage of a container platform's benefits. Nevertheless, moving applications from virtual machines to container platforms may present various challenges and considerations, such as dependency and library compatibility, configuration and state management, networking and inter-container communication, security, performance impacts, and the like. Each of these considerations may need to be taken into account to ensure successful transition to a container platform.

FIG. 2A is a high-level block diagram showing one example of a virtual machine platform 202. As shown, the virtual machine platform 202 operates on a hardware platform 200 (e.g., a physical server) and utilizes a hypervisor 204 to enable virtualization of physical hardware resources and manage multiple virtual machines 206 on the hardware platform 200. Each virtual machine 206 may include its own operating system 208 and one or more applications 210. VMware is one example of a virtual machine platform 202 that may be used to implement virtual machines 206.

FIG. 2B is a high-level block diagram showing one example of a container platform 224. As shown, the container platforms 224 operates on a host operating system 222 of a hardware platform 220. The container platform 224 may enable multiple containers 226 to share the host operating system 222. Applications 228 may run within each of these containers 226. Redhat OCP (i.e., Openshift Container Platform) is one example of a container platform 224 that may be used to implement containers 226.

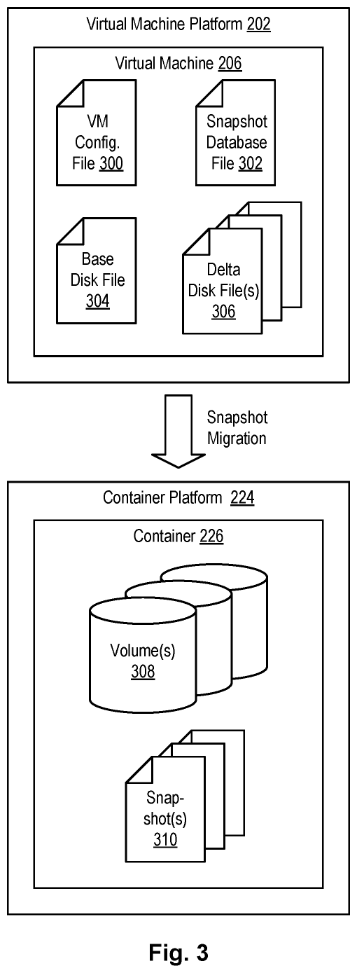

Referring to FIG. 3, one challenge encountered when migrating from a virtual machine platform 202 to a container platform 224 is how to move snapshots from the virtual machine platform 202 to the container platform 224. The relationship between snapshots in a virtual machine 206, as well as the way the snapshots are saved in the virtual machine environment, are very different from the way snapshots are created and saved in a container platform environment. For example, in a virtual machine 206 such as VMware, a base disk file 304 (e.g., a VMDK (Virtual Machine Disk) file) stores an image of a virtual machine 206. The base disk file 304 contains the contents of the virtual machine's virtual hard disk, which is used to store the operating system 208, applications 210, and data within the virtual machine 206. The base disk file 304 may serve as the virtual equivalent of a physical hard disk in a traditional computer.

When a snapshot of the virtual machine 206 is created, a delta disk file 306 is created in association with the snapshot. All changes made to the virtual machine 206 after creation of the snapshot will be stored in this delta disk file 306. The base disk file 304 will remain unchanged. Similarly, if a second snapshot is taken, a new second delta disk file 306 associated with the second snapshot may be created and all changes made to the virtual machine after creation of the second snapshot will be stored in the second delta disk file 306. In this way, the virtual machine 206 may utilize the base disk file 304 and delta disk files 306 to keep track of snapshots and use these files 304, 306 in the event the virtual machine 206 needs to be rolled back to a particular point in time that is associated with a snapshot.

Because snapshots have significant value and utility in situations such as disaster recovery, it may be desirable to preserve snapshots when transitioning from a virtual machine platform 202 to a container platform 224. Thus, systems and methods are needed to effectively migrate snapshots from virtual machine platforms 202 to container platforms 224.

FIG. 3 is a high-level block diagram showing various data structures that may be utilized in the virtual machine platform 202 and the container platform 224 when migrating snapshots between the platforms. As shown, a virtual machine 206 associated with the virtual machine platform 202 may include a virtual machine configuration file 300, snapshot database file 302, base disk file 304, and delta disk files 306. Similarly, a container 226 in the container platform 224 may include one more volumes 308 as well as snapshots 310 of the volumes 308.

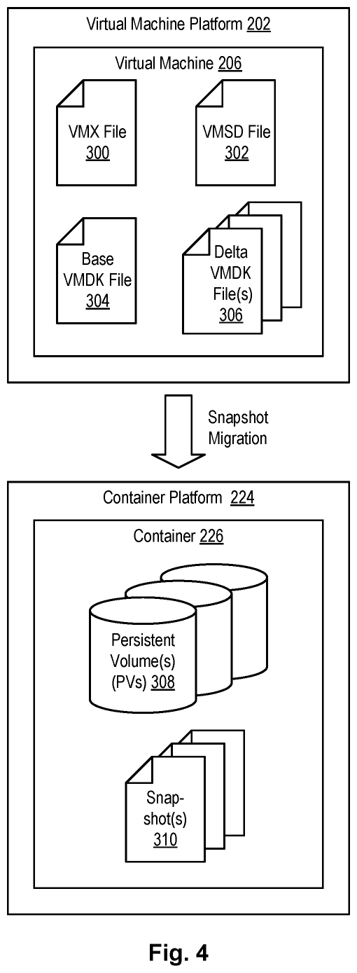

FIG. 4 is a high-level block diagram showing a more specific example of data structures that may be utilized in the virtual machine platform 202 and container platform 224 when migrating snapshots between the platforms. For example, in the VMware virtual machine platform 202, the virtual machine configuration file 300 may be referred to as a VMX file 300. A VMX file 300 is associated with each virtual machine 206 and contains configuration settings and parameters that define the virtual machine's hardware, operating system, and other characteristics. Similarly, in the VMware virtual machine platform 202, the snapshot database file 302 may be referred to as a VMSD (Virtual Machine Snapshot Database) file 302. The VMSD file 302 is primarily used to store metadata and information related to snapshots taken on a virtual machine 206. Similar, in the VMware virtual machine platform 202, the base disk file 304 may be referred to as a base VMDK file 302 and the delta disk files 306 may be referred to as delta VMDK files 306.

By contrast, in the Openshift Container Platform, volumes 308 may be Persistent Volumes 308. A Persistent Volume 308 represents a piece of storage that can be dynamically or statically provisioned by an administrator. Persistent Volumes 308 include resources that are independent of any specific application or user, and serve as an abstract layer between underlying storage and applications 228 that require storage. Snapshots 310 may be taken of these Persistent Volumes 308 but these snapshots 310 typically have a different configuration and structure than those generated for a virtual machine 206 in the VMware virtual machine platform 202.

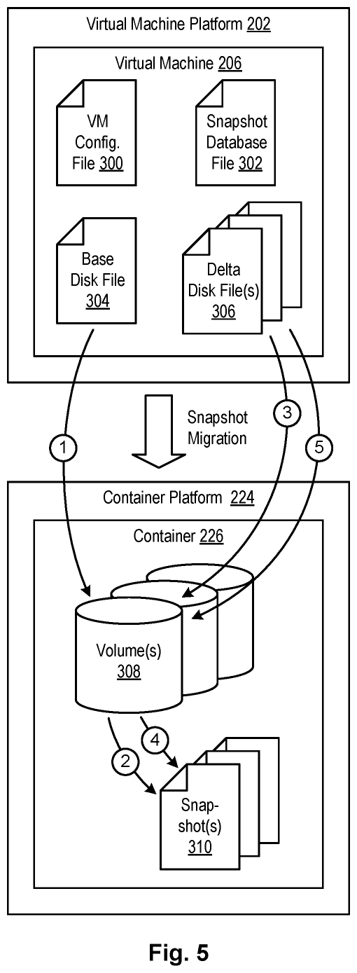

Referring to FIG. 5, as will be explained in more detail hereafter, in order to migrate snapshots from a virtual machine platform 202 to a container platform 224, various steps (labelled as one through five in this example) may be followed to account for the different ways that snapshots are created and stored on the platforms 202, 224. As shown in FIG. 5, in order to migrate snapshots from the virtual machine platform 202 to the container platform 224, a method in accordance with the invention may initially migrate a base disk file 304 from the virtual machine platform 202 to a volume 308 using a common storage class on the container platform 224 (i.e., step 1). Ideally, or mandatorily, the volume 308 will be a volume 308 that supports the taking of snapshots in the container platform 224.

If one or more snapshots are present on the virtual machine 206 (as indicated by the snapshot database file 302 and/or delta disk files 306) that need to be migrated, the method takes a snapshot 310 of the volume 308 (step 2). The method then migrates an oldest non-migrated delta disk file 306 from the virtual machine platform 202 to the container platform 224 and writes the changes recorded by this delta disk file 306 to the volume 308 (step 3), essentially updating the base disk file 304 with the changes from the delta disk file 306. If more snapshots exist on the virtual machine 206 that need to be migrated, the method once again takes a snapshot 310 of the volume 308 (step 4). The method then migrates the next oldest non-migrated delta disk file 306 from the virtual machine platform 202 to the container platform 224 and writes this delta disk file 306 to the volume 308 (step 5) to update the data contained therein with the changes from the delta disk file 306. This process may continue until all snapshots from the virtual machine platform 202 are migrated to the container platform 224.

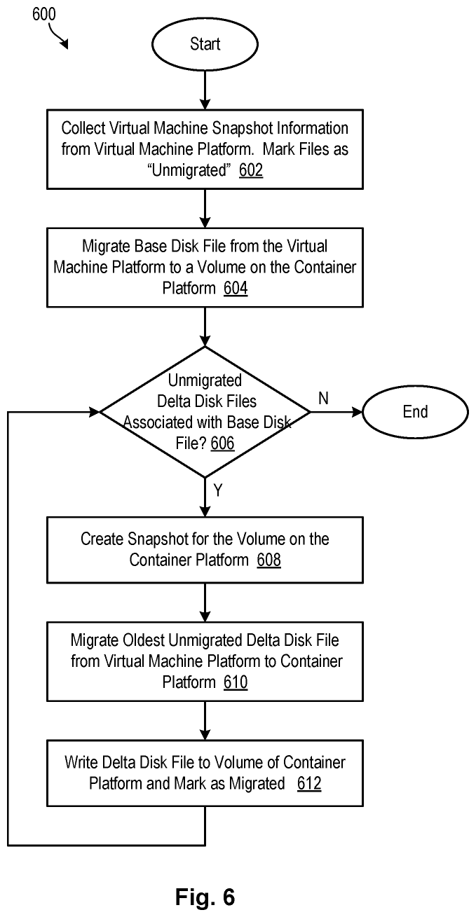

Referring to FIG. 6, one embodiment of a method 600 for migrating snapshots from a virtual machine platform 202 to a container platform 224 is illustrated. As shown, the method 600 initially collects 602 virtual machine snapshot information from the virtual machine platform 202. In certain embodiments, this may be accomplished by analyzing the virtual machine configuration file 300 and/or snapshot database file 302 associated with the virtual machine 206. The method 600 may then mark 602 any delta disk files 306 that have yet to be migrated to the container platform 224 as “unmigrated.” This may be as simple as establishing a boolean flag for each delta disk file 306 and setting the flag to reflect the unmigrated status of the delta disk file 306.

The method 600 then migrates 604 the base disk file 304 from the virtual machine platform 202 to a selected volume 308 on the container platform 224. At this point, the method 600 determines 606 whether the virtual machine 206 contains any unmigrated delta disk files 306 that are associated with the base disk file 304. If so, the method 600 creates 608 a snapshot of the volume 308 on the container platform 224. The method 600 then migrates 610 the oldest unmigrated delta disk file 306 from the virtual machine platform 202 to the container platform 224 and writes 612 the delta disk file 306 to the volume 308 containing the base disk file 304. The method 600 may then mark this delta disk file 306 as being migrated. This process may be repeated for all delta disk files 306 on the virtual machine 206 until all delta disk files 306 have been migrated from the virtual machine platform 202 to the container platform 224.

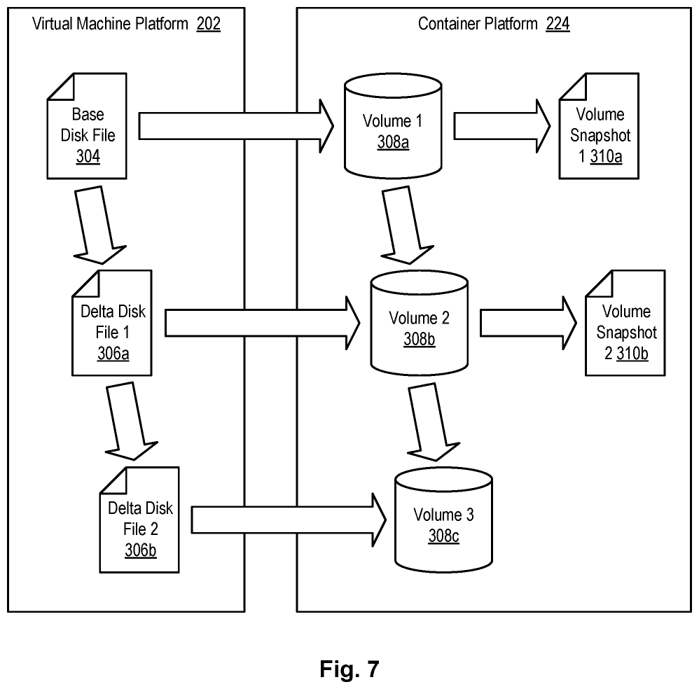

Referring to FIG. 7, a high level block diagram showing an exemplary sequence of actions that may be taken when migrating snapshots from a virtual machine platform 202 to a container platform 224 is illustrated. As shown in FIG. 7, in order to migrate snapshots from the virtual machine platform 202 to the container platform 224, a base disk file 304 may be initially migrated from the virtual machine platform 202 to a volume 308a on the container platform 224. In this example, assume that the virtual machine 206 includes two snapshots with two delta disk files 306a, 306b. In order to migrate the delta disk file 306a, a snapshot 310a may first be taken of volume 308a. The delta disk file 306a may then be migrated from the virtual machine platform 202 to the container platform 224 and combined with the contents of volume 308a to create volume 308b. In order to migrate the delta disk file 306b, a snapshot 310b may be taken of volume 308b. The delta disk file 306b may then be migrated from the virtual machine platform 202 to the container platform 224 and combined with the contents of volume 308b to create volume 308c. After the migration of delta disk files 306a, 306b is complete, volume 308c will contain the latest state of the virtual machine 206. Furthermore, using the snapshots 310a, 310b, the container platform 224 may revert back to any of the points in time associated with any of the snapshots migrated from the virtual machine platform 202.

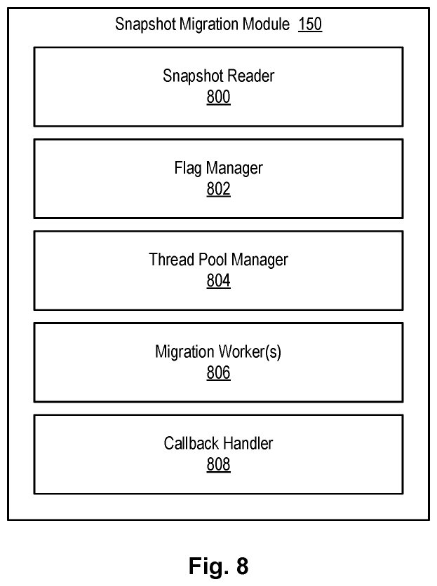

Referring to FIG. 8, in certain embodiments, functionality may be provided to enable snapshots of a virtual machine 206 to be migrated to a container platform 224 in parallel to improve the efficiency of performing the migration. FIG. 8 shows one embodiment of a snapshot migration module 150 that may be used to migrate snapshots in parallel. The snapshot migration module 150 and associated sub-modules 800-810 may be implemented in hardware, software, firmware, or combinations thereof. The snapshot migration module 150 and associated sub-modules are presented by way of example and not limitation. More or fewer sub-modules may be provided in different embodiments. For example, the functionality of some sub-modules may be combined into a single or smaller number of sub-modules, or the functionality of a single sub-module may be distributed across several sub-modules.

As shown, in certain embodiments, the snapshot migration module 150 includes one or more of a snapshot reader 800, flag manager 802, thread pool manager 804, migration workers 806, and callback handler 808.

The snapshot reader 800 reads snapshot information from the snapshot database file 302 (e.g., the VMSD file 302) in order to identify delta disk files 306 that correspond to each snapshot on a virtual machine 206. The snapshot reader 800 may also store the snapshot information in a data structure or database for later use.

The flag manager 802 implements a flag mechanism to mark each delta disk file 306 with a value that indicates whether the delta disk file 306 has or has not been migrated to the container platform 224. The flag manager 802 may also update a flag value associated with a delta disk file 306 after the delta disk file 306 has been migrated, as well as check the flag value for a delta disk file 306 to determine if it needs to be migrated.

The thread pool manager 804 (which may also be referred to as a task queue manager 804) uses a thread pool or task queue to assign delta disk files 306 to different threads or tasks that can run in parallel or asynchronously. The thread pool manager 804 may also create, start, stop, and monitor the threads or tasks and handle any exceptions or errors that may occur.

Migration workers 806 may be configured to migrate assigned delta disk files 306 from the virtual machine platform 202 to the container platform 224 and write the changed data into the volumes 308. The migration workers 806 may also, in certain embodiments, be configured to verify the integrity of the data that is migrated as well as report the result of the migration.

The callback handler 808 may use a callback or promise function to handle the completion or failure of each delta disk file 306 that is migrated. The callback handler 808 may also update the flag mechanism, log the migration result, and handle any errors that may occur during the migration.

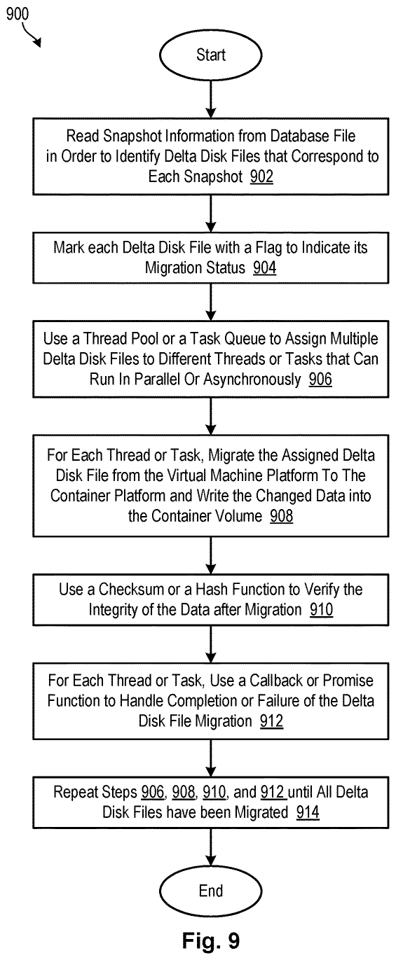

Referring to FIG. 9, a process flow diagram showing one embodiment of a method 900 that may be executed by the snapshot migration module 150 is illustrated. As shown, the method 900 initially reads 902 snapshot information from the snapshot database file 302 in order to identify delta disk files 306 that correspond to each snapshot on the virtual machine 206. The method 900 marks 904 each delta disk file 306 with a flag to indicate its migration status. The method 900 then uses 906 a thread pool or task queue to assign delta disk files 306 to different threads or tasks that can run in parallel or asynchronously.

For each thread or task, the method 900 migrates 908 the assigned delta disk file 306 from the virtual machine platform 202 to the container platform 224 and writes 908 the changed data associated with the delta disk file 306 into the container volume 308. The method 900 may use 910 a checksum or hash function to verify the integrity of the data that was migrated. For each thread or task, the method 900 may use a callback or promise function to handle completion or failure of the migration of the delta disk file 306. The method 900 repeats 914 steps 906, 908, 910, and 912 until all delta disk files 306 have been successfully migrated to the container platform 224.

The flowcharts and block diagrams in the Figures illustrate the architecture, functionality, and operation of possible implementations of systems, methods, and computer program products according to various embodiments of the present invention. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other implementations may not require all of the disclosed steps to achieve the desired functionality. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

1. A method for migrating virtual machine snapshots to application container platforms, the method comprising:
migrating, from a virtual machine platform to a volume on a container platform, a base disk file associated with a virtual machine, the base disk file having at least one delta disk file associated therewith, each delta disk file recording changes made to the virtual machine after a snapshot was taken;
after migrating the base disk file, repeatedly performing the following for each delta disk file:
take a snapshot of the volume on the container platform;
migrate the delta disk file from the virtual machine platform to the container platform; and
write the delta disk file to the volume.

2. The method of claim 1, wherein writing the delta disk file to the volume further comprises marking the delta disk file as migrated from the virtual machine platform to the container platform.

3. The method of claim 2, wherein marking the delta disk file as migrated comprises setting a flag associated with the delta disk file.

4. The method of claim 1, wherein the base disk file is a base VMDK (Virtual Machine Disk) file.

5. The method of claim 1, wherein the delta disk files are delta VMDK files.

6. The method of claim 1, further comprising verifying that the volume supports snapshots in the container platform.

7. The method of claim 1, wherein the delta disk files are written to the volume in an order in which they were created on the virtual machine.

8. A computer program product for migrating virtual machine snapshots to application container platforms, the computer program product comprising a computer-readable storage medium having computer-usable program code embodied therein, the computer-usable program code configured to perform the following when executed by at least one processor:
migrate, from a virtual machine platform to a volume on a container platform, a base disk file associated with a virtual machine, the base disk file having at least one delta disk file associated therewith, each delta disk file recording changes made to the virtual machine after a snapshot was taken;
after migrating the base disk file, repeatedly perform the following for each delta disk file:
take a snapshot of the volume on the container platform;
migrate the delta disk file from the virtual machine platform to the container platform; and
write the delta disk file to the volume.

9. The computer program product of claim 8, wherein writing the delta disk file to the volume further comprises marking the delta disk file as migrated from the virtual machine platform to the container platform.

10. The computer program product of claim 9, wherein marking the delta disk file as migrated comprises setting a flag associated with the delta disk file.

11. The computer program product of claim 8, wherein the base disk file is a base VMDK (Virtual Machine Disk) file.

12. The computer program product of claim 8, wherein the delta disk files are delta VMDK files.

13. The computer program product of claim 8, wherein the computer-usable program code is further configured to verify that the volume supports snapshots in the container platform.

14. The computer program product of claim 8, wherein the delta disk files are written to the volume in an order in which they were created on the virtual machine.

15. A system for migrating virtual machine snapshots to application container platforms, the system comprising:
at least one processor;
at least one memory device operably coupled to the at least one processor and storing instructions for execution on the at least one processor, the instructions causing the at least one processor to:
migrate, from a virtual machine platform to a volume on a container platform, a base disk file associated with a virtual machine, the base disk file having at least one delta disk file associated therewith, each delta disk file recording changes made to the virtual machine after a snapshot was taken;
after migrating the base disk file, repeatedly perform the following for each delta disk file:
take a snapshot of the volume on the container platform;
migrate the delta disk file from the virtual machine platform to the container platform; and
write the delta disk file to the volume.

16. The system of claim 15, wherein writing the delta disk file to the volume further comprises marking the delta disk file as migrated from the virtual machine platform to the container platform.

17. The system of claim 15, wherein the base disk file is a base VMDK (Virtual Machine Disk) file.

18. The system of claim 15, wherein the delta disk files are delta VMDK files.

19. The system of claim 15, wherein the instructions further cause the at least one processor to verify that the volume supports snapshots in the container platform.

20. The system of claim 15, wherein the delta disk files are written to the volume in an order in which they were created on the virtual machine.
